(19) United States
(12) Patent Application Publication
(10) Pub. No.: US 2013/0332903 A1
(43) Pub. Date: Dec. 12, 2013

(54) SYSTEM AND METHODS FOR DETERMINING DECOMPOSITION GRAPH COMPLEXITY

(71) Applicant: Massively Parallel Technologies, Inc., Boulder, CO (US)

(72) Inventor: Kevin D. Howard, Tempe, AZ (US)

(21) Appl. No.: 13/912,906

(22) Filed: Jun. 7, 2013

Related U.S. Application Data
(60) Provisional application No. 61/657,244, filed on Jun. 8, 2012.

(51) Int. Cl. G06F 9/44

(52) U.S. Cl. CPC G06F 8/75
USPC 717/123

(57) ABSTRACT

A method for generating a decomposition graph having an effective cyclomatic complexity measure below the McCabe limit for a decomposition level, includes the steps of determining the number of processes and/or objects within the decomposition level, determining a cyclomatic complexity measure based on the number of processes and/or objects within the decomposition level, determining a number of dimensions required to display the decomposition level such that the cyclomatic complexity does not exceed the McCabe limit, and generating the decomposition graph based on the determined number of dimensions required to display the decomposition level.

### RELATED APPLICATIONS

This Application claims the benefit of priority to U.S. Provisional Patent Application No. 61/657,244, filed Jun. 8, 2012, incorporated herein by reference in its entirety.

### BACKGROUND

Cyclomatic Complexity indicates the complexity of a program by directly measuring the number of linearly independent paths through a program's source code. Thomas J. McCabe, Sr., in his work on cyclomatic complexity (McCabe T., A Complexity Measure, IEEE Transactions on Software Engineering, December 1976, incorporated herein by reference) showed that a code snippet with greater than ten separate branches is very difficult to maintain. This number (10) matches well with the known number of short-term memory slots available to humans (seven plus or minus two). Essentially the number of separate code branches accessible at one time should roughly match the number of short-term memory slots. Since a non-decomposable process on, for example, an MPT decomposable high level design graph is equivalent to a code branch and further since the visible complexity of a decomposable graph process is the same as that of a non-decomposable process for any particular decomposition level, then having more than ten processes on any visible portion of a particular decomposition level is also essentially un-maintainable.

### SUMMARY

By generating a decomposition graph with an effective cyclomatic complexity measure at or below the McCabe limit, it may be possible to insure that the complexity of the graph does not exceed human capability. Generating a decomposition graph with an effective cyclomatic complexity measure at or below the McCabe limit includes determining the complexity measure of a decomposition level, i.e., the number of processes/objects in at least one level of a decomposed software product, and determining if that complexity measure exceeds the McCabe limit. If the complexity measure does not exceeds the McCabe limit, the decomposition level is displayed as a 2D decomposition graph. If the complexity measure exceeds the McCabe limit, the decomposition level is displayed as a 3D decomposition graph with rotation capabilities.

In an embodiment, a method for generating a decomposition graph having an effective cyclomatic complexity measure below the McCabe limit for a decomposition level, includes the steps of determining the number of processes and/or objects within the decomposition level, determining a cyclomatic complexity measure based on the number of processes and/or objects within the decomposition level, determining a number of dimensions required to display the decomposition level such that the cyclomatic complexity does not exceed the McCabe limit, and generating the decomposition graph based on the determined number of dimensions required to display the decomposition level.

In an embodiment, a method for determining complexity of a decomposition graph for a decomposed software product including one or more decomposition levels, includes the steps of processing each of the one or more decomposition levels to determine a number of processes and/or objects within each of the one or more decomposition levels, executing a complexity display to process the decomposed software product based on the determined number of processes and/or objects, and calculating a number of dimensions required to graphically display each of the one or more decomposition levels of the processed decomposed software product.

In an embodiment, a method for displaying a three-dimensional decomposition graph having reduced cyclomatic complexity, includes the steps of processing each of one or more decomposition levels of a decomposed software product to determine a number of processes and/or objects within each of the one or more decomposition levels, executing a complexity display to process the decomposed software product based on the determined number of processes and/or objects, determining a shape required to display the three-dimensional decomposition graph at an effective cyclomatic complexity at or below the McCabe limit, and generating the three-dimensional composition graph based on the determined shape.

In an embodiment, a system for determining complexity of a decomposition graph for a decomposed software product by a decomposition manager, includes a storage including a software product, a memory including a decomposer, a decomposed software product, and a complexity display function, and a processor for executing the decomposer to process the software product of the storage into the decomposed software product of the memory. The complexity display is capable of processing the decomposed software product to determine how to display the decomposed software product with a cyclomatic complexity at or below the McCabe limit.

### BRIEF DESCRIPTION OF THE DRAWINGS

FIG. 1 shows a process of a standard 2D decomposition graph, in an embodiment.

FIGS. 2A and 2B show examples of 3D decomposition graphs (with rotation), in an embodiment.

FIG. 3 shows an example of a shadow 3D method with forward and backward rotation symbol, in an embodiment.

FIG. 4 schematically illustrates an example of multiple-pages method with thumb-nails, in an embodiment.

FIG. 5 shows an example of a method for generating a 3D decomposition graph having an effective cyclomatic complexity measure below the McCabe limit, in an embodiment.

FIG. 6 schematically illustrates an example of a system for generating a 3D decomposition graph having an effective cyclomatic complexity measure below the McCabe limit, in an embodiment.

### DETAILED DESCRIPTION OF THE FIGURES

Considering the inherent complexity of today's software, insuring that ten or fewer processes occur per decomposition level is difficult. The present inventor has discovered that a way to insure a proper process limit, yet stay true to the actual requirements of the code, is to increase the number of dimensions used to display the decomposition graph.

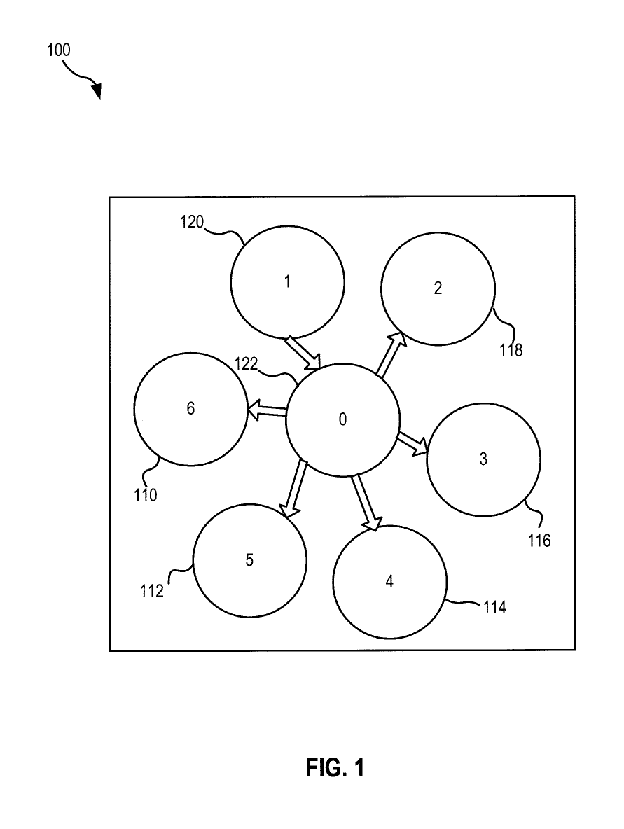

FIG. 1 shows processes/objects on a standard two-dimensional (2D) decompositional graph 100. Graph 100 includes objects 110-122. FIG. 1 illustrates how the conventional 2D view can rapidly saturate with objects and eventually exceed the McCabe limit.

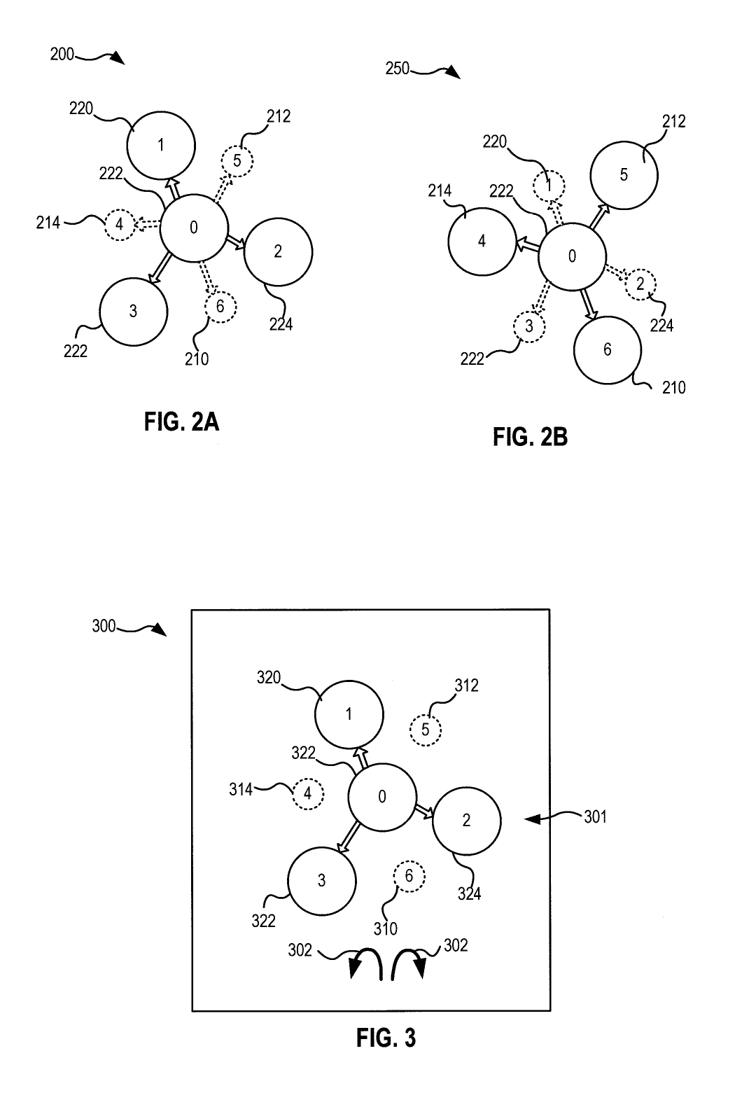

FIGS. 2A and 2B show three-dimensional (3D) decompositional graphs 200, 250, respectively. 3D Decomposition Graphs 200, 250 may be utilized to display a set of processes/objects 210-222 such that the McCabe limit is not exceeded. For example, in the embodiment shown in FIG. 2A, processes 210, 212, 214 are “hidden,” or de-emphasized, while processes 220, 222, 224 are made visible or otherwise emphasized. For access, processes 210, 212, 214 may be rotated into view for analysis (see FIG. 2B), while processes 220, 222, 224 may be rotated out of view to reduce the number of displayed objects in order to stay under the McCabe limit. In other words, according to an embodiment, many of the processes may be kept hidden until needed, and then rotated into view for analysis when desired. By this system, all processes may be kept available, but unnecessary processes will not clutter the display for a viewer.

### Shadow Method

FIG. 3 shows a 3D shadow format 300 for displaying process bubbles in a 3D decompositional graph 301. Format 300 may be utilized to cause the rotation of graph 301. According to this “shadow method,” format 300 may visibly emphasize the processes 310, 312, 314 as bubbles, while still also showing unneeded (at the moment) processes 320, 322, 324 as de-emphasized smaller and/or see-through process bubbles. Rotation may be performed by selecting the forward rotation symbol 304 or backward rotation symbol 302, as shown in FIG. 3.

### Multiple-Page Method

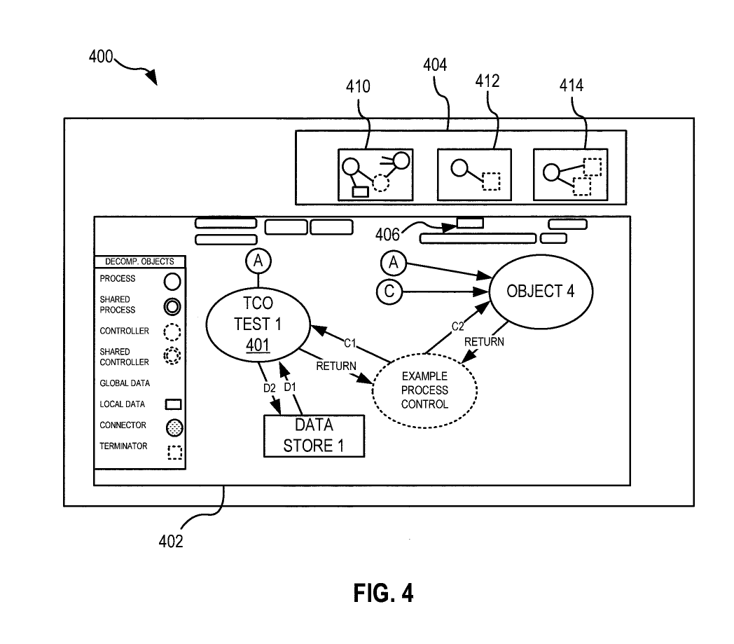

FIG. 4 shows a multiple-page display, which may limit the display to only the processes, e.g., process 401, for the current page 402. According to this embodiment, other processes may be visible on their own respective page(s). Accessing additional pages may be performed by first viewing a thumbnail of all pages 404, for example, by selecting a “Page” button 406, and selecting a desired page from displayed page thumbnails 410, 412, 414. Selection of a desired page thumbnail 410, 412, 414 may cause a full size version of the page to appear, allowing a user to interact with the page.

### Decomposition Complexity Determination and Display

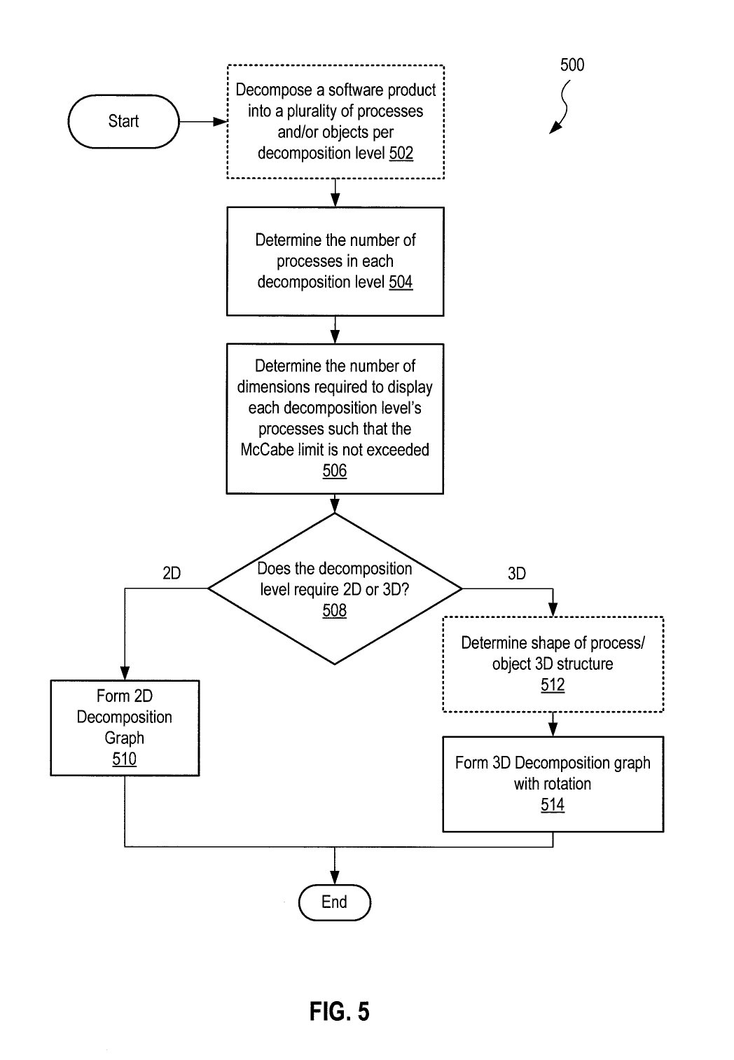

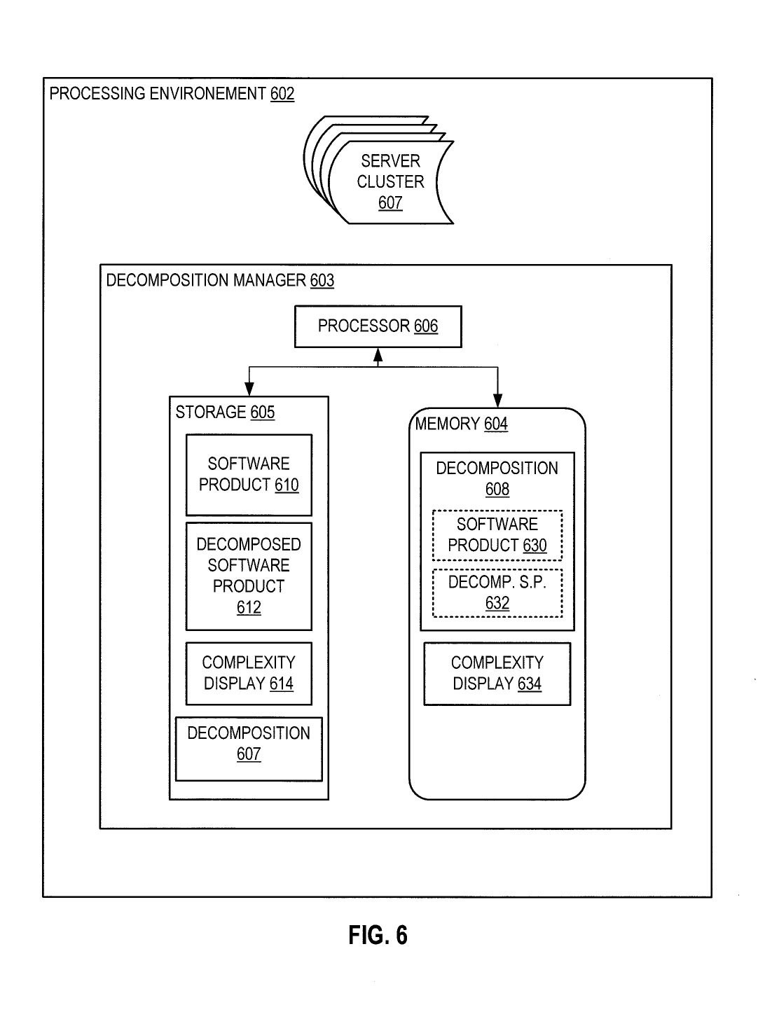

FIG. 5 shows a method 500 for generating a 3D decomposition graph having an “effective” cyclomatic complexity measure below the McCabe limit. FIG. 6 shows a decomposition manager 603. FIGS. 5 and 6 may be viewed cooperatively together. In an embodiment, method 500 may decomposes the source code of a software application on the one hand, or may take as an input a previously decomposed software source code on the other hand. Method 500 may then display a resultant output of such inputs as a decomposition graph having reduced cyclomatic complexity or reduced “effective” cyclomatic complexity with a measure below the McCabe limit. The decomposition graph with a reduced effective cyclomatic complexity can then be a 3D representation of a decomposition graph, which representation may then be rotated. That is, a portion of the displayed data may be de-emphasized, for example, by “rotating” a portion of the 3D representation to the background (see FIGS. 2A, 2B, and 3). Thus the 3D decomposition graph's foreground/emphasized information can be represented in a new manner that is nonetheless consistent with Thomas J. McCabe's work on Cyclomatic Complexity and the McCabe limit, In other words, according to this embodiment, the background/de-emphasized information can be visible, yet without cluttering the display space for a viewer.

According to the embodiment shown in FIG. 5, optional step 502 may serve to decompose a software product into a one or more decomposition levels, each of such decomposition levels having one or more of processes and/or objects, which processes and/or objects may then be displayed. In an example of step 502, a processor 606 of a decomposition manager 603 may copy a software product 610 into a memory 604 as a software product 630, as best seen in FIG. 6. A decomposer 608 may then decompose software product 630 and produce a decomposed software product 632. Decomposed software product 632 may include a plurality of decomposition levels, each including one or more processes of objects.

Further according to the embodiment of FIG. 5, step 504 may then determine a number of processes and/or objects in each decomposition level. In an example of step 504, decomposer 608 may process each decomposition level of software product 632 to determine the number of processes and/or objects in each decomposition level. Method 500 may begin with step 502, or begin directly with step 504, as illustrated in FIG. 5.

Next, in step 506, method 500 may calculate the number of “dimensions” required to display each decomposition level, such that either a true or an effective cyclomatic complexity measure at or below the McCabe limit may be maintained. A true cyclomatic complexity may be represented two-dimensionally, whereas an effective cyclomatic complexity may be represented three-dimensionally. In an example of step 506, processor 606 may execute a complexity display 634, thereby processing the decomposed software product 632 to calculate the number of dimensions (e.g., two or three dimensions) desirable to display a decomposition graph for each decomposition level of the decomposed software product 632 in order to maintain a cyclomatic complexity measure at or below the McCabe limit.

Step 508 is a decision step. In step 508, if step 506 determined a 2D decomposition graph may be used to display the decomposition graph, decision step 508 moves to step 510. In step 510, a 2D decomposition graph may be generated, and the process of method 500 may conclude. However, if step 506 determined a 3D decomposition graph may be used to display the decomposition graph, decision step 508 may instead moves to step 514 directly, or first to step 512 prior to step 514. In optional step 512, method 500 may determine the simplest shape necessary to display the decomposition graph while maintaining an effective cyclomatic complexity measure below the McCabe limit. In other words, step 512 may determine the shape of the process/object 3D structure of the decomposition graph that may be based upon the number of input processes/objects and/or the number of connections. Less complex decomposition graphs may be viewed by rotating the displayed graph twice, each at a 180 degree rotation. More complex decomposition graphs may require more rotations to view all aspects of the displayed graph, for example, four 90 rotations in one direction, or rotations left or right, and up or down. More or less complex 3D decomposition graphs may be generated without departing from the scope herein. In step 514, a 3D decomposition graph may be generated, and the process of method 500 may conclude.

In an embodiment, method 500 need not decompose a software product, but may alternatively accept a previously decomposed software product and processes the previously decomposed software product to generate a decomposition graph with reduced cyclomatic complexity measure.

Referring back to FIG. 6, the decomposition manager 603 within a parallel processing environment 602 is schematically illustrated. The decomposition manager 603 may include the memory 604, a storage 605, and the processor 606. The storage 605 may include the software product 610, a decomposed software product 612, a function for a complexity display 614, and a function for a decomposition 607. In an embodiment, the processor 606 may save the decomposition 607 function to the memory 604 as the decomposer 608 and the complexity display 614 as the complexity display 634. The processor 606 may then copy the software product 610 to the memory 604 as the software product 630, and then execute the decomposer 608. The decomposer 608 may then process the software product 630 to generate the decomposed software product 632. The complexity display 634 may then process the decomposed software product 632 to determine how to display the decomposed software product with reduced cyclomatic complexity, preferably having a cyclomatic complexity measure less than the McCabe limit, as described above. The processor 606 may then save the decomposed software product 632 as the decomposed software product 612 in the storage 605.

In an embodiment, the decomposition manager 603 is located in, or otherwise co-operates with, a standard computer system, i.e., a personal computer that does not exist within a parallel processing environment. In this embodiment, the decomposition manager may need to contain information such that a resulting decomposed software product may function properly within a designated parallel processing environment, e.g., processing environment 602.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might he said to fall therebetween.

What is claimed is:

1. A method for generating a decomposition graph having an effective cyclomatic complexity measure below the McCabe limit for a decomposition level, comprising the steps of:
determining the number of processes and/or objects within the decomposition level;
determining a cyclomatic complexity measure based on the number of processes and/or objects within the decomposition level;
determining a number of dimensions required to display the decomposition level such that the cyclomatic complexity does not exceed the McCabe limit; and
generating the decomposition graph based on the determined number of dimensions required to display the decomposition level.

2. The method of claim 1, further comprising the step of determining the shape of a decomposition graph, wherein the shape depends on the determined number of processes and/or objects.

3. A method for determining complexity of a decomposition graph for a decomposed software product including one or more decomposition levels, comprising the steps of:
processing each of the one or more decomposition levels to determine a number of processes and/or objects within each of the one or more decomposition levels;
executing a complexity display to process the decomposed software product based on the determined number of processes and/or objects; and
calculating a number of dimensions required to graphically display each of the one or more decomposition levels of the processed decomposed software product.

4. The method of claim 3, further comprising the step of, prior to the step of processing, decomposing a non-decomposed software product into a plurality of processes and/or objects for each of the one or more decomposition levels.

5. The method of claim 3, wherein the calculated number of dimensions is two.

6. The method of claim 3, wherein the calculated number of dimensions is three.

7. The method of claim 6, further comprising the step of, after the step of calculating, determining a shape required to display the decomposition graph at an effective cyclomatic complexity at or below the McCabe limit.

8. A method for displaying a three-dimensional decomposition graph having reduced cyclomatic complexity, comprising the steps of:
processing each of one or more decomposition levels of a decomposed software product to determine a number of processes and/or objects within each of the one or more decomposition levels;
executing a complexity display to process the decomposed software product based on the determined number of processes and/or objects;
determining a shape required to display the three-dimensional decomposition graph at an effective cyclomatic complexity at or below the McCabe limit; and
generating the three-dimensional composition graph based on the determined shape.

9. The method of claim 8, wherein the generated three-dimensional composition graph includes rotational capability.

10. The method of claim 9, wherein the rotational capability comprises at least two 180 degree rotations.

11. The method of claim 9, wherein the rotational capability comprises at least four 90 degree rotations.

12. The method of claim 8, wherein the generated three-dimensional composition graph visually de-emphasizes unnecessary processes.

13. A system for determining complexity of a decomposition graph for a decomposed software product by a decomposition manager, comprising:
a storage including a software product;
a memory including a decomposer, a decomposed software product, and a complexity display function; and
a processor for executing the decomposer to process the software product of the storage into the decomposed software product of the memory,
wherein the complexity display is capable of processing the decomposed software product to determine how to display the decomposed software product with a cyclomatic complexity at or below the McCabe limit.

14. The system of claim 13, wherein the processor is capable of copying the software product from the storage into the memory prior to processing by the decomposer.

15. The system of claim 13, wherein the decomposition manager is maintained within a parallel processing environment.

16. The system of claim 13, wherein the decomposition manager is maintained within a personal computer.
